(19) United States
(12) Patent Application Publication
(10) Pub. No.: US 2004/0042097 A1
(43) Pub. Date: Mar. 4, 2004

(54) Flexible prism for directing spectrally narrow light

(76) Inventors: Andrew J. Murnan, Webster, NY (US); William R. Houde-Walter, Rush, NY (US)

Correspondence Address: Steven R. Scott, Eugene Stephens & Associates, Inc., 56 Windsor Street, Rochester, NY, 14605, US

(21) Appl. No.: 10/453,004

(22) Filed: Jun. 3, 2003

Related U.S. Application Data
(60) Provisional application No. 60/386,101, filed on Jun. 5, 2002.

(51) Int. Cl. G02B 5/04; G02B 7/18

(52) U.S. Cl. 359/831

(57) ABSTRACT

The flexible prism is comprised of two thin, rigid, optically transparent plates sandwiching an optically transparent deformable material such as a transparent liquid or a transparent flexible solid. The index of refraction for all of the materials is preferably matched, such that reflections between interfaces are minimized. The liquid/flexible material used in this flexible prism may consist of almost any substantially transparent material that is not rigid like a solid glass. The angles of one or both of the rigid surfaces of the flexible prism can be selectively adjusted with a respect to a spectrally narrow beam of light passing through the prism so as to produce the refraction desired.

This application claims the benefit of U.S. Provisional Application No. 60/386,101, filed on Jun. 5, 2002, which provisional application is incorporated by reference herein.

### FIELD OF THE INVENTION

Our invention relates generally to the optical steering of a spectrally narrow beam of light.

### BACKGROUND OF THE INVENTION

A several methods exist for steering of a beam of collimated light. One method is to simply adjust the pitch and yaw (X and Y-axis) of the entire light source to aim the beam in a new direction. However, this is not always desirable if the light source is mechanically constrained, the cost of mechanical adjustment is expensive, or the speed of mechanically adjusting the entire light source is too slow for the intend application.

A very common arrangement is to use a mirror to fold the collimated beam in a new direction. This has had great success in devices ranging from astronomical telescopes to Digital Mircromirror Devices. This method is not ideal in all cases. The one mirror can no longer steer the beam as if it was a transmissive optical element. To have the redirected beam propagate in the direction of the original beam, more than one mirror is required, which decreases the linearity of the optical system.

One technique to maintain the linearity of an optical system is to use a transmissive lens or a series of lenses that collimate a beam of light. The lens can then transmit the beam on forward in a collimated fashion. If one wants to redirect the beam slightly, either the lens or the original light source must de-center a small amount. This introduces aberrations in the light beam thereby decreasing its optical quality. Secondly, it decreases the linearity of the system a small amount, as it now requires some mechanism of adjustment from the side, which decreases the compactness of a linear system.

A method of maintaining a high optical quality collimated light beam that is linear in fashion is to use a series of two optical prisms. The two in-series prisms have the ability to steer a spectrally narrow optical light beam by rotating the two prisms around their individual center or optical axis and does not increase the non-linearity of the optical system. However, they may be slow to adjust whether electrically controlled or mechanically controlled and the added expenses of the prisms themselves may not be justified for some optical systems.

Lastly, Electro-optical systems use a nonlinear optical feature that is not present in the other methods, but do maintain a single on-axis optical system. The steering speed is relatively fast, but these Electro-optical systems are very expensive and have some attenuation of the light beam.

Nonetheless, despite the existence of the above-referenced systems, there exists the need for transmissive on-axis optical systems for directing a spectrally narrow beam of light that are: low cost when mechanically adjusted to steer the light beam; have the potential of high steering speed when electrically controlled; and will remain relatively low cost (compared to other methods of steering an optical light beam) when electrically controlled.

### SUMMARY AND OBJECTS OF THE INVENTION

Our invention has the ability to transmit and steer a spectrally narrow light beam without introducing significant aberrations into the beam using an optical system that is all on one optical axis and is relatively low in cost. It is based on the use of a flexible prism. In the preferred embodiment of our invention, this flexible prism is comprised of two thin rigid plates. These plates, which are preferably formed from glass, are substantially transparent to the frequency of the spectrally narrow light beam. However, they need not be flat--one or both surfaces of either plate can be curved (and in this way produce, e.g., a collimating lens). Sandwiched between these plates is a deformable material that is substantially transparent to the frequency of the spectrally narrow light beam. However, The deformable material may take the form of a substantially transparent liquid or a substantially transparent flexible solid. The index of refraction for all of the materials are preferably matched, such that reflections between interfaces are minimized. However, even though it presents additional problems, our invention can function when the indexes of refraction of the various parts making up the flexible prism are different. The liquid/flexible material used in our flexible prism may consist of silicone, baby oil, uncured UV adhesive, or other material that is not rigid like a solid glass.

In the preferred embodiments, where indexes of refraction are identical, the flexible prism can be treated as having only the two surfaces of a normal solid prism. Thus, when a laser (or other light source that is made to be spectrally narrow via a filter or other device) illuminates the flexible prism, it is directed in the same manner it would be directed by a normal solid prism. To begin with, it enters the flexible prism where the first flat surface it encounters is a rigid material that may or may not be coated to reduce back reflections. If the first surface is normal then the light will not refract and will pass directly onto the final flat surface, since the inside of the prism is index matched to the rest of the materials. At this final surface, refraction will take place and the beam will be deflected from the optical axis by an amount correlating to the angle of the final surface with respect to the optical axis.

The surfaces of the flexible prism can be mechanically adjusted to produce the refraction desired. This mechanical adjustment of the prism surfaces can be accomplished by means of adjustment of other components via screws, piezoelectric transducers, and/or through magnetic or capacitive changes on the mounts of the flexible prism. In addition, both surfaces of the prism may be adjusted to ease the electrical or mechanical constraints on the optical system.

Our flexible prism can also be used to switch a light beam on or off. If the light beam is headed towards the final surface, and this surface is at a critical angle or greater, then the light will not refract out of the system. The light beam will instead have close to one hundred percent reflection back into the prism. This is beneficial if the user needs to have zero percent transmission in the optical system. Thus, our flexible prism system can control the transmission properties of the optical system in an on/off manner. In effect, this serves to digitalize the system.

Further, if the device is equipped with a fast means for accomplishing mechanical adjustments, such as electrical means, then our optical system can act as a scanner in two dimensions. In the act of scanning, it can also act as an optical switch: It is “on” when the prism surfaces are set to specific angles such that the light beam is deflected to another optical system or to a detector. The surface angles of the optical prism can then be adjusted relative to the optical axis such that the light is deflected to another optical system, a detector, or nothing at all. (The last alternative represents an “off” state like that made possible by a Digital Micromirror Device).

The foregoing uses and benefits are, however, by no means exhaustive in nature. As should be obvious from the foregoing, the flexible prism of our invention is relatively simple in construction and operation. Moreover, it can be inexpensively produced and used. However, it is extremely versatile and can be used in innumerable ways to aim, adjust, digitalize, switch, or otherwise control a spectrally narrow beam of light.

### BRIEF DESCRIPTION OF DRAWINGS

FIG. 1 provides a schematic perspective view of a flexible prism in accordance with the teachings of this invention.

FIG. 2 provides a schematic perspective view of the flexible prism shown in FIG. 1 while it is subject to a force causing the final surface to be angled relative to the first surface.

FIG. 3 provides a schematic side view of a mounted flexible prism showing the path of an unrefracted light beam through the prism.

FIG. 4 provides a schematic side view of the mounted flexible prism illustrated in FIG. 3 while it is subject to a force causing the final surface to be angled relative to the first surface and the path of the light beam through the prism to be refracted.

FIG. 5 provides a schematic side view of a mounted flexible prism having a flexible substance surrounding the flexible transparent material at its center.

FIG. 6A provides a schematic side view of a mounted flexible prism showing adjustment screws for use in causing the final surface to be angled relative to the first surface of the flexible prism.

FIG. 6B provides a schematic frontal view of the mounted flexible prism illustrated in FIG. 6A showing its four adjustment screws.

FIG. 7 provides a schematic cross-sectional view of a laser sight utilizing a flexible prism for adjustment purposes.

FIG. 8 provides a schematic perspective view of a smaller flexible prism.

FIG. 9 provides a schematic perspective view, of an array of smaller flexible prisms.

FIG. 10 provides a schematic side view of two pairs of prisms where light is directed to the out of line member.

FIG. 11 provides a schematic side view of two pairs of prisms where light is directed to the in line member.

FIG. 12 provides a schematic side view of a flexible prism at the critical angle that directs a light beam to suffer total internal reflection.

### DETAILED DESCRIPTION

Our invention is used in conjunction with an optical system to create a mechanism for redirecting or steering a spectrally narrow collimated beam of light. A light beam is sent into a flexible prism 16 whereby the beam is refracted, following Snell's law of refraction, and propagates to the final surface of the flexible prism 16 where the light beam is refracted again. The amount refraction is a function of the wavelength of the light beam and also the relative angles between the first surface and the final surface.

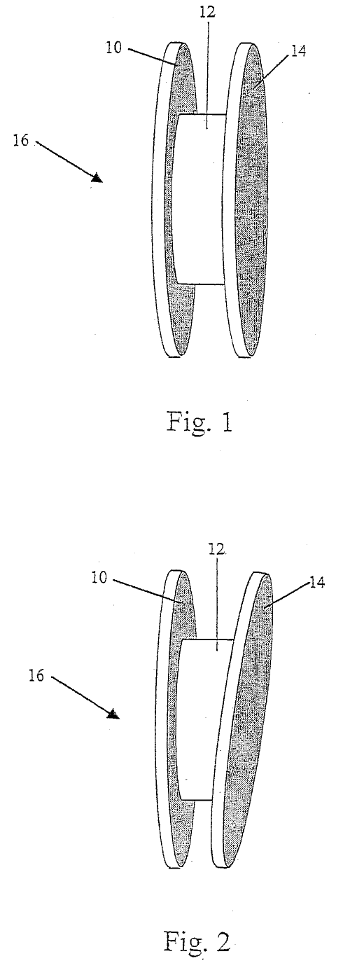

A basic embodiment of our flexible prism invention 16 is shown in FIGS. 1 and 2. These figures show a front and back solid plate 10, 14 made out of glass, plastic, or some other rigid, optically transparent material. The flexible substance 12 located at its center between plates 10, 14 will typically consists of silicone, baby oil, epoxy, solgel, uncured/cured UV adhesive, or some other material that is not rigid like a solid glass. (Preferably, it will be index matched to the substance(s) forming the plates 10, 14.) This allows the plates to be angled relative to each other as shown in FIG. 2.

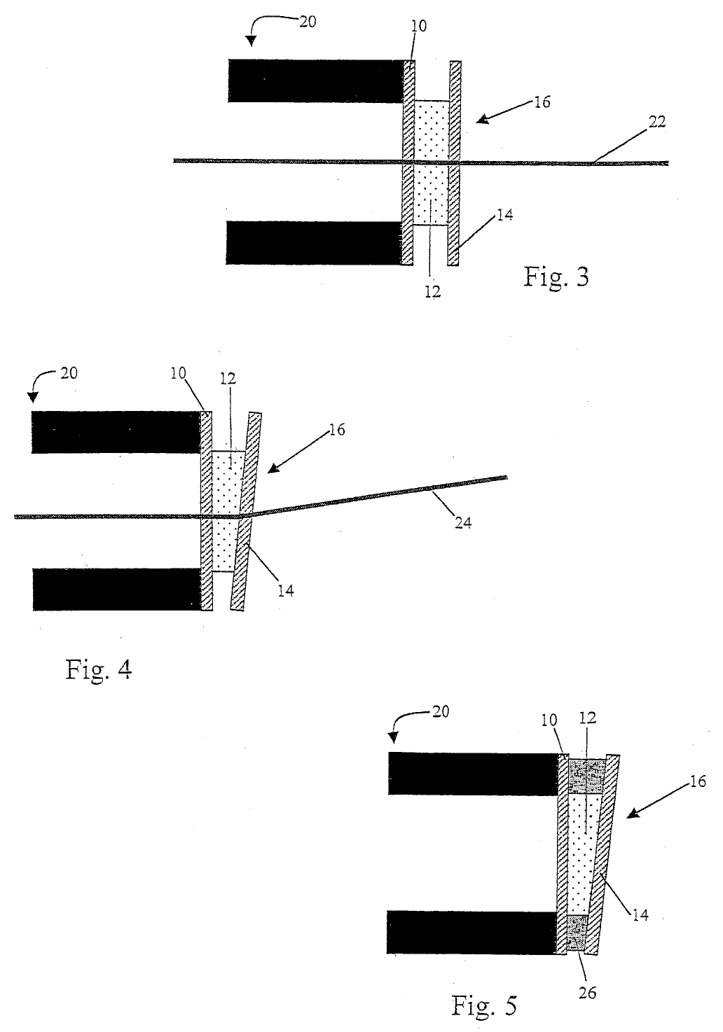

As illustrated in FIGS. 3, 4, 5, and 6, our flexible prism 16 will typically be mounted at the end of an optical system 20 to steer a light beam 22, 24. In this case, the flexible prism 16 is mounted to the optical system in any fashion that allows transmission of the incoming optical light beam. For example, in FIGS. 3, 4, 5, and 6, the invention's back plate 10 is bonded with an adhesive to optical system 20. FIG. 3 illustrates a light beam 22 passing through flexible prism 16 when it is under no force such that plates 10 and 14 are parallel to one another. In this circumstance, the direction of light beam 22 remains unchanged. However, when one of the plates is angled in some fashion relative to the other plate, light beam 24 is refracted in accordance with Snell's Law, changing the direction of light beam 24. (See e.g., FIG. 4).

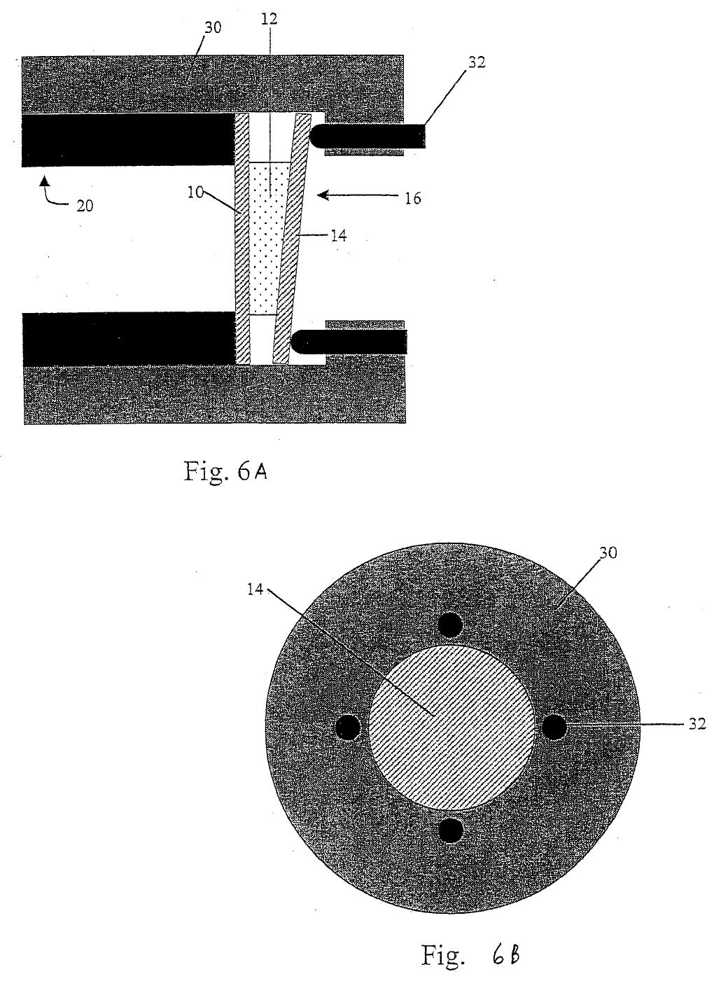

If the force that caused one of the plates, either 10 or 14, to be angled relative to the other is released, then the flexible substance 12, if resilient, can act like a spring to force the plates 10, 14 back to their original parallel position. However, this is dependent on the nature of the flexible substance used. Some of the substances envisioned for use in our invention, such as baby oils, will not have this characteristic. In this case, a material 26 that is resilient can be placed around substance 12 and can also be used to provide resiliency. (See, FIG. 5). Resilient material 26 can also serve to maintain a liquid media used for flexible substance 12 in position. Alternatively, where one or both angled plates are to be fixed, an adhesive may be used for material 26 and used to fill up the gaps between plates 10 and 14 and substance 12. Material 26 and/or flexible substance 12 can be cured in place if they are curable adhesives. This allows the flexible prism 16 to maintain its shape even after an original force imposed on it is released.

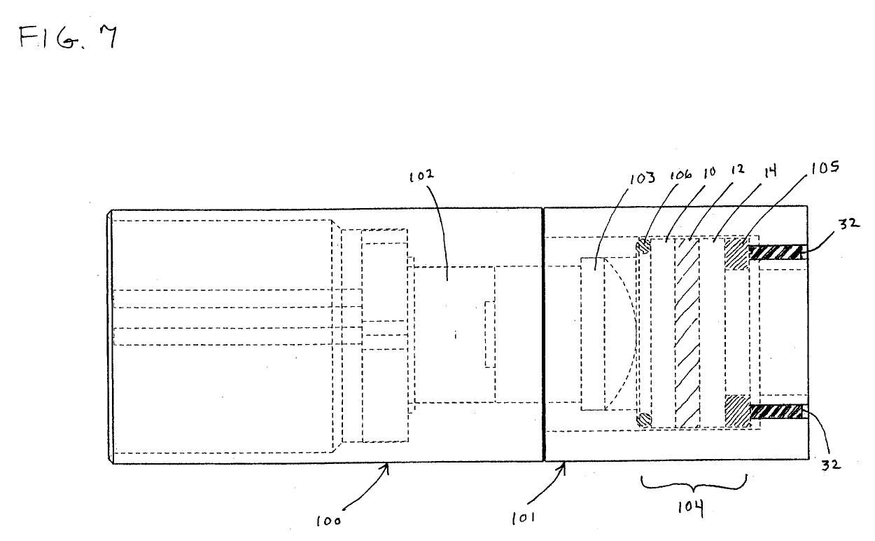

A force causing one or both of the plates 10, 14 to be angled can be provided by various deformation systems. One example can be seen in FIGS. 6A, 6B, and 7. FIG. 6A provides a side view of a flexible prism 16 mounted on the front of an optical system 20 with adjustment screws 32 in its housing 30 serving as actuators for its deformation system. The front view of this arrangement is shown in FIG. 6A. In this system, screws 32 are adjusted to apply force on plate 14 such that plate 14 is angled relative to plate 10. This configuration allows the user to then steer the beam to a new direction simply by adjusting screws 32.

The type of robust deformation system illustrated in FIGS. 6A and 6B is suitable for numerous uses, including use in adjustment of laser alignment systems (also known as laser sighting systems) such as those used in surveying and with firearms. In the context of firearms, the system illustrated in FIGS. 6A and 6B could be considered as part of a laser module positioned on a firearm, in a firearm's barrel, or in the recoil spring guide for an automatic pistol as described in U.S. Pat. Nos. 4,934,086 and 5,509,226. In these applications, the illustration shown in FIG. 6A would constitute a view of the laser beam emitting end of a laser module. A more specific example of the use of our invention in a laser sight is seen in FIG. 7, which illustrates a laser sight having a body 100 coupled to a head 101. A laser diode 102 is positioned in body 100 so as to project a laser beam forward through a collimating lens 103 in head 101. From there it would travel through the flexible prism assembly (indicated generally by bracket 104). Flexible prism assembly 104 includes plates 10, 14 sandwiching flexible substance 12, as in past embodiments illustrated. It is adjusted by exerting pressure on an intermediate rigid washer 105 by screws or otherwise as previously discussed. Washer 105 helps to insure that uneven pressure does not result in the breakage of plate 14. It is assisted in this by the presence of a flexible O-ring 106 that serves as a shock absorbing and cushioning base for plate 10.

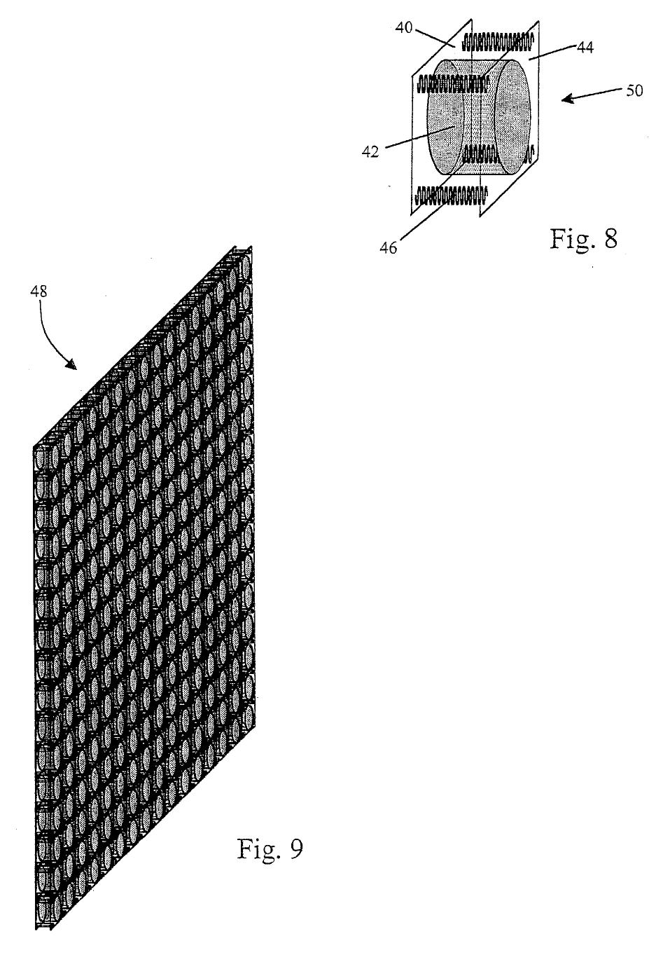

Our flexible prism 16 can also be miniaturized so as to become a small flexible prism 50 as shown in FIG. 8. The front and back plates 44, 40 can still be made out of any solid transparent material while substance 42 still transmits some portion of the desired wavelength(s). Actuators 46 for a deformation system are shown schematically. At these small scales, flexible substance 42 can be controlled to some degree electrically as with liquid crystal. If flexible prism 50 is small enough, the mechanical forces applied by actuators 46 could be provided via capacitive, electrostatic, thermal, acoustical and/or magnetic actuators. If the flexible prism 50 is small, yet too large for the previously mentioned forces, then small mechanical forces could be applied by actuators 46 via piezoelectric transducers to control one or both plates 40, 44.

Systems using small flexible prisms 16 such as those described are extremely useful in photonics, where they allow rapid switching, digitalization and precise control of optical systems. For example, a small flexible prism 50 could be mounted to an optical conductor such as an optical fiber that has had exiting light collimated with a lens. The small flexible prism 50 could then steer the light beam from the fiber to another optical conductor or fiber and act as an optical switch.

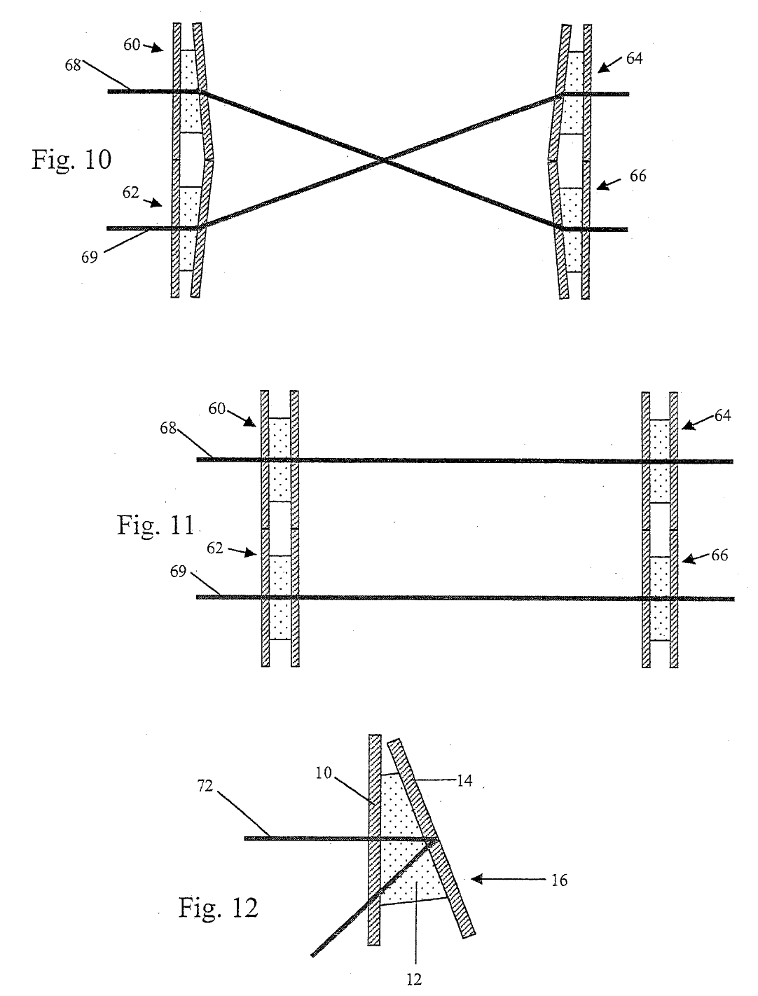

Taking this idea further, FIG. 9 shows a two dimensional array 48 of these miniature flexible prisms 50 that could be made to steer a multitude of light beams. FIGS. 10 and 11 provide diagrammatic side views showing a smaller array of 4 miniature flexible prisms 50 steering two light beams with the capability to switch back and forth. In FIG. 10, miniature flexible prisms 60 direct light beam 68 to flexible prism 66, which receives the light beam 68 and redirects the beam such that it is parallel to the original incoming beam 68 on prism 60. Prism 62 directs light beam 69 to prism 64, which receives the light beam 69 and redirects the beam such that it is parallel to the original incoming beam 69 on prism 62. If no deformation system forces are applied, as shown in FIG. 11, beam 68 passes directly through prism 60 and on to prism 64. Likewise, beam 69 passes directly through prism 62 and on to prism 66.

Finally, FIG. 12 illustrates a situation where a flexible prism 16 is deformed to such an extent that plate 14 is at the critical angle or greater relative to plate 10. In this case light beam 72 will suffer total internal reflection off of the last surface where plate 14 meets the air interface. This does not allow any light to pass though flexible prism 16.

We claim:

1. An apparatus, comprising:
a source that can be activated to project a spectrally narrow light beam; and
adjustment apparatus for adjusting the direction of the beam emitted by the source, the adjustment apparatus including a flexible prism element intersected by said beam that can be selectively deformed so as to adjust the direction of said beam.

2. An apparatus as described in claim 1, wherein said flexible prism element is resiliently biased so as to return to a particular configuration after it has been selectively deformed.

3. An apparatus as described in claim 1, wherein said flexible prism element includes a deformable material intersected by said beam, which material is substantially transparent to said beam.

4. An apparatus as described in claim 3, wherein said deformable material is resiliently biased so as to return to a particular configuration after it has been selectively deformed.

5. An apparatus as described in claim 3, wherein said deformable material includes at least one of a liquid and a resilient solid.

6. An apparatus as described in claim 1, wherein said flexible prism element includes a rigid plate intersected by said beam, which plate is substantially transparent to said beam.

7. An apparatus as described in claim 3, wherein said flexible prism element includes a rigid plate intersected by said beam, which plate abuts said deformable material intersected by said beam and is substantially transparent to said beam.

8. An apparatus as described in claim 7, wherein the material forming said plate and said deformable material have the same index of refraction.

9. An apparatus as described in claim 1, further comprising a deformation apparatus for selectively deforming said flexible prism element.

10. An apparatus as described in claim 7, wherein said deformation apparatus includes at least one of a mechanical, capacitive, electrostatic, magnetic, piezoelectric, thermal and acoustical actuator.

11. An apparatus as described in claim 7, further comprising a deformation apparatus for selectively deforming said flexible prism element by angular movement of said plate relative to said intersecting beam.

12. An apparatus as described in claim 1, further comprising other materials, which other materials resiliently bias said prism element to return to a particular configuration after it has been selectively deformed.

13. An apparatus as described in claim 3, further comprising other materials, which other materials surround and encompass said substantially transparent deformable material.

14. An apparatus as described in claim 1, wherein said flexible prism includes flexible materials that can be made rigid so as to affix the flexible prism in a particular configuration after it has been selectively deformed.

15. An apparatus as described in claim 1, wherein said flexible prism can interrupt transmission of the beam through the flexible prism.

16. An apparatus as described in claim 1, wherein said spectrally narrow light beam is a laser beam.

17. An apparatus as described in claim 16, wherein said laser beam is incorporated into a laser sighting system.

18. An apparatus as described in claim 17, wherein said sighting system is a laser sighting system for a firearm and is arranged to project said laser beam parallel to a firearm barrel.

19. An apparatus as described in claim 1, further comprising a receiver for said spectrally narrow light beam, which receiver is capable of further directing said beam.

20. An apparatus as described in claim 19, wherein said receiver includes an optical conductor.

21. An apparatus as described in claim 20, wherein said optical conductor includes an optical fiber.

22. An apparatus as described in claim 20, wherein said conductor includes another flexible prism element.

23. An apparatus as described in claim 21, wherein said conductor includes another flexible prism element.

24. An apparatus as described in claim 1, further comprising a plurality of receivers for said spectrally narrow light beam, each of which said plurality of receivers is capable of further directing said beam, and said adjustment apparatus can adjust the direction of said beam so as to send it to any of said plurality of receivers.

25. An apparatus as described in claim 1, wherein said spectrally narrow light beam is a laser beam and said laser beam is incorporated into a laser scanner.

26. An apparatus, comprising:
a source that can be activated to project a spectrally narrow light beam; and
adjustment apparatus for adjusting the direction of the beam, the adjustment apparatus including a flexible prism element formed by sandwiching a substantially transparent deformable material between two rigid plates formed from substantially transparent materials, which flexible prism element can be selectively deformed so as to selectively direct the beam passing through said flexible prism element.

27. An apparatus as described in claim 26, wherein said flexible prism can interrupt transmission of the beam through the flexible prism.

28. An apparatus as described in claim 1, wherein said spectrally narrow light beam is a laser beam.

29. An apparatus as described in claim 28, wherein said laser beam is incorporated into a laser sighting system.

30. An apparatus as described in claim 29, wherein said sighting system is a laser sighting system for a firearm and is arranged to project said. laser beam parallel to a firearm barrel.

31. An apparatus as described in claim 26, further comprising at least one receiver for said spectrally narrow light beam, each such receiver being capable of further directing said beam, and said adjustment apparatus can adjust the direction of said beam so as to send it to any such receiver.

32. An apparatus as described in claim 1, wherein said spectrally narrow light beam is a laser beam and said laser beam is incorporated into a laser scanner.

33. A laser sighting system, comprising:
a source that can be activated to project a laser beam;
a first rigid plate formed from substantially transparent materials, said first plate being intersected by, and set at a particular angle to, said beam;
a second rigid plate formed from substantially transparent materials, said second plate being intersected by, and set at a particular angle to, said beam;
a substantially transparent deformable material intersected by said beam intermediate and abutting said first plate and said second plate; and
plate movement apparatus for selectively altering the angle of at least one of said first plate and said second plate so as to selectively direct said beam.

34. An apparatus as described in claim 33, wherein said source is arranged to project said laser beam parallel to a firearm barrel

35. A method for adjusting the direction of a laser beam, comprising:
providing a flexible prism element formed by sandwiching a substantially transparent deformable material between two rigid plates formed from substantially transparent materials, which flexible prism element can be selectively deformed so as to selectively direct said laser beam;
positioning said flexible prism element so that said plates and said transparent deformable material are intersected by and set at particular angles to said laser beam; and
providing plate movement apparatus for selectively altering the angle of at least one of said plates so as to selectively direct said laser beam.
